(19) United States
(12) Patent Application Publication
(10) Pub. No.: US 2019/0170104 A1
(43) Pub. Date: Jun. 6, 2019

(54) ANTI-COKING INJECTOR ASSEMBLY FOR A DIESEL DOSING UNIT, AND METHODS OF CONSTRUCTING AND UTILIZING SAME

(71) Applicant: Continental Automotive Systems, Inc., Auburn Hills, MI (US)

(72) Inventors: Christopher Michael Caulkins, Virginia Beach, VA (US); Keith Aaron Shaw, Yorktown, VA (US); Robert Wayne McFarland, Smithfield, VA (US)

(73) Assignee: Continental Automotive Systems, Inc., Auburn Hills, MI (US)

(21) Appl. No.: 15/833,683

(22) Filed: Dec. 6, 2017

(51) Int. Cl. F02M 65/00; F02M 61/10; F02M 61/18; F02M 61/20

(52) U.S. Cl. CPC F02M 65/008; F02M 61/10; F02M 2200/8084; F02M 61/20; F02M 2200/06; F02M 61/18

(57) ABSTRACT

An attachment assembly for a fluid injector includes a housing having a first end and a second end; a seat disposed within the housing; and a needle in the housing having a first end, the needle movable between a first position in which the first end of the needle provides a sealing engagement with the seat so as to prevent fluid from exiting the second end of the housing, and a second position in which the first end of the needle extends outwardly from the second end of the housing spaced apart from the seat for allowing fluid in the housing to exit through the second end; and a spring member biasing the needle towards the first position to prevent fluid in the housing from exiting the second end. The first end of the housing attaches to the fluid outlet of a fuel injector for providing an integrated injector assembly.

### CROSS REFERENCE TO RELATED APPLICATION

The present application is related to U.S. provisional application ______, filed ______, and having attorney docket number 2017P08478US, the content of which is incorporated by reference herein.

### FIELD OF THE INVENTION

The present invention relates generally to an attachment to a fuel injector for creating a unitary, outward opening injector assembly for use in applications in which the injector is susceptible to coking.

### BACKGROUND

In a diesel engine, exhaust gas temperature management is critical for meeting emissions requirements. One method of exhaust gas temperature management is known as “post-injection” which utilizes an additional injection of fuel from the in-cylinder fuel injector during the exhaust stroke. Post-injection is known to cause oil dilution and requires more frequent engine maintenance. Another method of exhaust gas temperature management is a dedicated system that injects fuel directly into the exhaust stream. In particular, diesel fuel is delivered or otherwise sprayed into the exhaust stream in front of a diesel oxidation catalyst in order to provide the thermal energy required to re-burn captured particulates at the diesel particulate filter or to thermally manage the exhaust system temperature conditions. The delivery device is referred to as a diesel dosing unit (DDU). Because dedicated systems for performing these methods are on-demand, there may extended periods of inactivity. Extended periods of high temperature and inactivity have been seen to cause the DDU injector to be stuck in the closed position. This leads to complicated injector designs, including remotely mounting DDU injectors from the diesel engine exhaust pipe and complex thermal isolation of the DDU injector.

### SUMMARY

Example embodiments of the present disclosure overcome shortcomings of injectors and satisfy a need for an improved anti-coking injector with resistance to being stuck in the closed position. According to an example embodiment, there is provided a fluid injector assembly having an attachment assembly. The attachment assembly includes a housing having a first end and a second end, the housing at least partly defining a fluid path between the first end of the housing and the second end thereof; a seat fixedly disposed within the housing; and a needle movably disposed within the housing and including a first end portion. The needle is movable between a first position in which the first end portion of the needle contacts and provides a sealing engagement with the seat so as to prevent fluid from exiting the housing through the second end thereof, and a second position in which the first end portion of the needle extends outwardly from the second end of the housing and is spaced from the seat of the attachment assembly for allowing fluid in the housing to exit the housing through the second end thereof. The attachment assembly further includes a spring member disposed within the housing and coupled to the needle so as to bias the needle towards the first position and prevent fluid in the housing from exiting the housing through the second end thereof. The first end of the housing is attached to a fluid outlet of a fluid injector having an inward opening valve, with the fluid path of the housing being in fluid communication with a fluid path of the fluid injector. The resulting combination of the fluid injector and the attachment assembly is suitable for use in applications in which injectors are susceptible to coking and being stuck in a closed state.

In at least some example embodiments, the fluid injector includes an injector housing, a fluid inlet disposed at a first end of the injector housing for receiving fluid, and a fluid outlet disposed at a second end of the injector housing for exiting fluid therefrom. The injector housing defines at least in part an injector fluid path through the injector housing between the fluid inlet and the fluid outlet. The fluid injector further includes an actuator unit and a valve assembly operably coupled thereto for selectively discharging fluid in the injector fluid path from the fluid outlet when the valve assembly is in an open state and for preventing fluid in the injector fluid path from exiting the fluid outlet when the valve assembly is in a closed state. The first end of the housing of the attachment assembly is connected to the fluid injector at or near the fluid outlet thereof.

In an example embodiment, the fluid injector is a fuel injector and the fluid injector assembly is a fuel injector or a diesel dosing unit (DDU) injector. In another example embodiment, fluid injector is a gasoline based port fuel injector.

When the valve assembly of the fluid injector is in the open state, fluid in the fluid injector exits the fluid injector from the fluid outlet thereof and enters the fluid path of the housing of the attachment assembly so as to cause the needle to overcome the bias of the spring member and move to the second position, and when the valve assembly of the fluid injector is in the closed state, fluid in the fluid injector is prevented from passing into the fluid path of the housing of the attachment assembly so as to cause the spring member to bias the needle of the attachment assembly to move to the first position.

In an example embodiment, the housing of the attachment assembly is laser welded to the second end of the injector housing, and the seat of the attachment assembly is laser welded to the housing thereof.

The attachment assembly may further include a spring stop disposed in the housing of the attachment assembly. A first end of the spring member is coupled to the spring stop and a second end of the spring member is coupled to the seat of the attachment assembly. The spring stop is connected to an axial end of the needle, and the needle, the seat, the spring and the spring stop form a subassembly of the attachment assembly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a fluid injector according to an example embodiment;

FIG. 2 is a partial cross sectional side view of the fluid injector of FIG. 1; and

FIG. 3 is a detailed cross sectional view of an attachment assembly of the fluid injector of FIGS. 1 and 2.

### DETAILED DESCRIPTION

The following description of the example embodiment(s) is merely exemplary in nature and is in no way intended to limit the invention, its application, or uses.

Example embodiments of the present disclosure are directed to an injector assembly which utilizes an existing inward-opening fluid injector, such as a fuel injector, as the metering device of the injector assembly, and an attachment assembly which is connected to the fuel outlet of the fuel injector and which includes an outward opening valve. The resulting injector assembly is suitable as an injector for a DDU (i.e., a DDU injector) or for other applications in which a fluid injector is susceptible to coking. For reasons of simplicity, the injector assembly will be described hereinbelow for use as a DDU injector for a diesel dosing system (DDS).

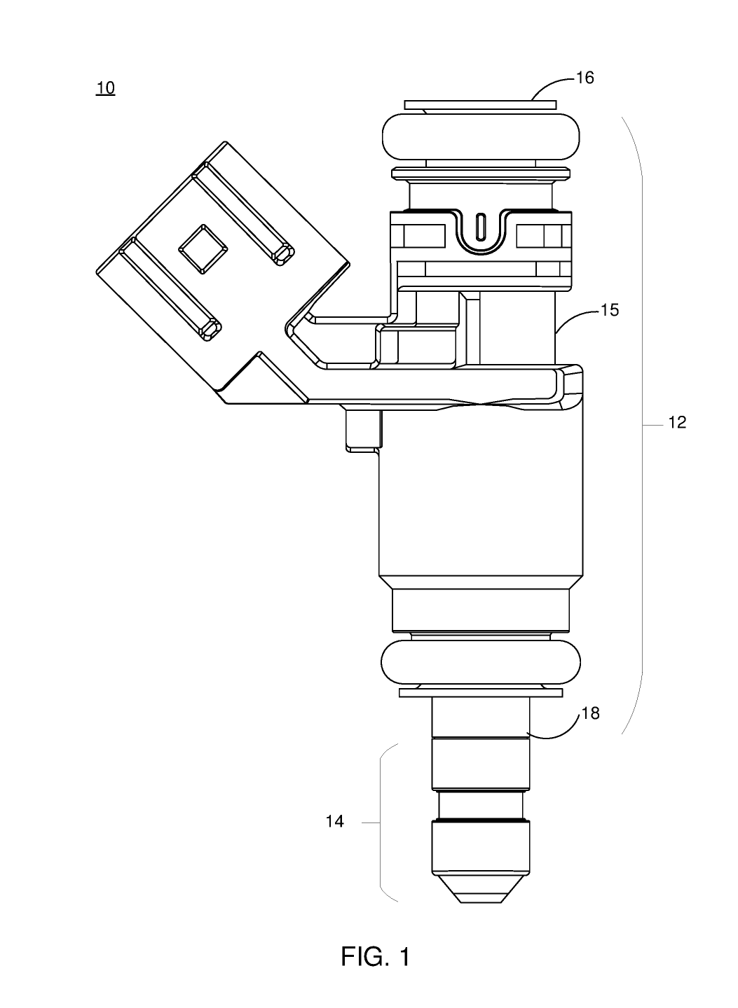

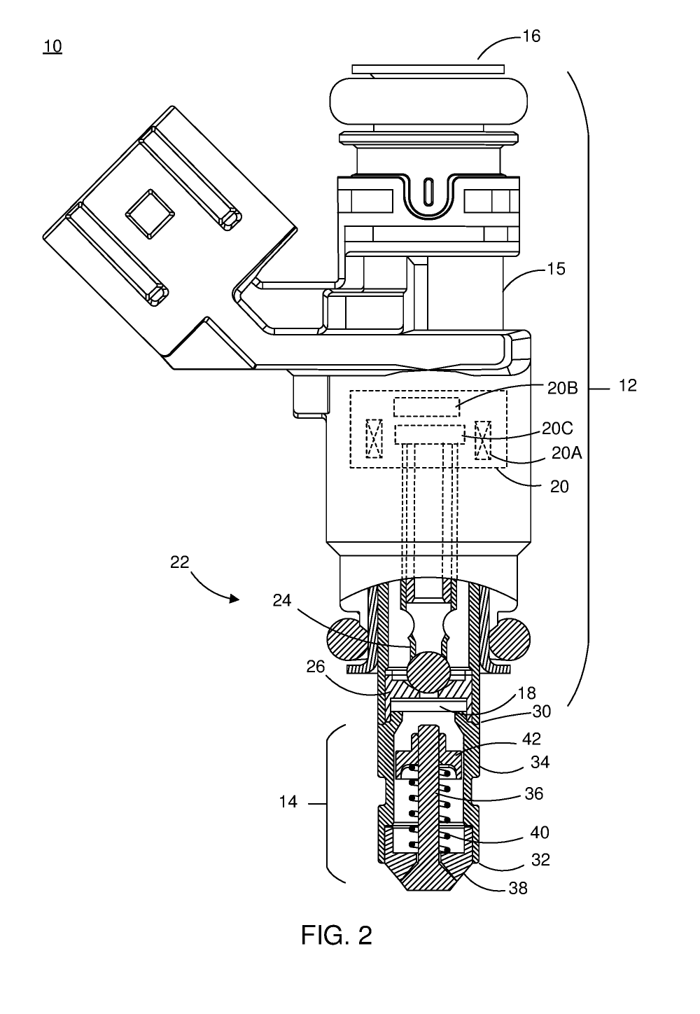

Referring now to the FIGS. 1 and 2, there is shown an injector assembly 10 which is resistant to coking. According to an example embodiment, injector assembly 10 includes a fluid injector 12 and an attachment assembly 14 attached to a downstream end of fluid injector 12. Fluid injector 12 is an existing fluid injector, such as an existing fuel injector. In one example embodiment, fluid injector 12 is a gasoline based port fuel injector. Fluid injector 12 is an inward opening fluid injector and/or has a valve assembly which is inward opening. In the example embodiments, fluid injector 12 is utilized in injector assembly 10 as the metering device for controlling the flow of fluid exiting injector assembly 10. In the context of injection assembly 10 forming a DDU injector, fluid injector 12 meters the flow of diesel fuel from fluid injector 12 for injection into the exhaust pipe of a diesel engine. Use of an existing, relatively low cost injector, such as an existing fuel injector and particularly an existing gasoline based port fuel injector, provides a simplified, inexpensive and more robust injector assembly 10.

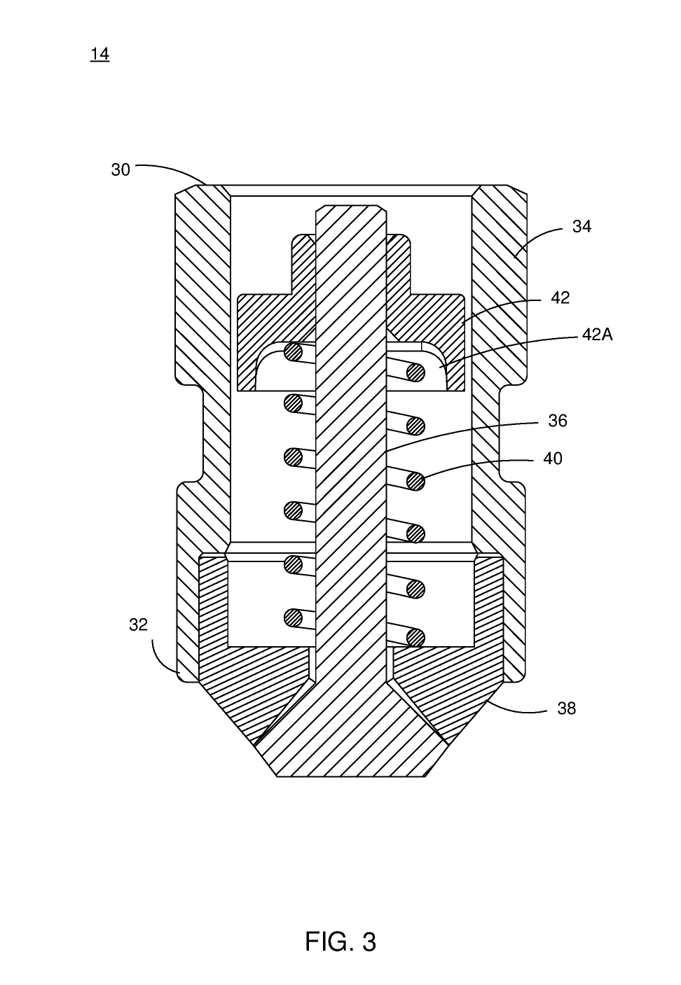

It is understood that fluid injector 12 may be any of a number of different inward opening fluid/fuel injectors. In general terms, fluid injector 12 includes components and/or parts commonly found in fluid injectors: a housing 15; a fluid inlet 16 in which fluid is received from a fluid source; and a fluid outlet 18 which provides a metered flow of fluid exiting fluid injector 2. Housing 15 may at least partly define a fluid path between fluid inlet 16 and fluid outlet 18. Fluid injector 12 may further include an actuator unit 20 disposed within housing 15. In an example embodiment, actuator unit 20 includes a coil 20A, pole piece 20B and a movable armature 20C disposed in proximity to coil 20A. Energizing coil 20A, such as by passing a current through the coil, causes armature 20C to move in an axial direction within housing 15 towards pole piece 20B. Fluid injector 12 may further include a valve assembly 22 having an axially movable valve needle 24 with one end coupled to armature 20C and a second end; and a valve seat 26 disposed at or near the fluid outlet 18 of fluid injector 12. Valve needle 24 is movable between a first (closed) position in which the second end of valve needle 24 sealingly contacts valve seat 26 so that fluid in fluid injector 12 is prevented from exiting through fluid outlet 18 (shown in FIGS. 2 and 3), and a second (open) position in which the second end of valve needle 24 is moved in an upstream direction, relative to the flow of fluid through fluid injector 12, so that the second end of valve needle 24 is spaced apart from valve seat 26 to allow fluid in the fluid path of fluid injector 12 to exit through fluid outlet 18. A spring (not shown) is disposed in the housing 15 and coupled to armature 20C to bias the armature away from pole piece 20B, which biases the valve needle 24 to the first (closed) position. Energizing coil 20A causes armature 20C to move so that the valve needle 24 moves to the second (open) position. In this way, the inward opening valve assembly 22 is controlled via coil 20A to open and close the valve assembly to selectively provide a metered amount of fluid from fluid injector 12.

Best seen in FIG. 2 and, in an enlarged view, in FIG. 3, attachment assembly 14 includes a housing having a first (upstream) end 30 and a second (downstream) end 32. Attachment assembly 14 further includes, disposed in housing 34, an outward opening valve subassembly including a needle 36, seat 38, return spring 40 and spring stop 42. Needle 36 and seat 38 each includes a sealing surface which when engaged with each other, provides a seal which prevents fluid in housing 34 from exiting through second end 32 thereof. Spring stop 42 includes a pocket 42A defined along one axial side thereof which receives an end portion of spring 40. A second end portion of spring 40 engages with seat 38. An axial end portion of needle 36 is connected to spring stop 42, and a central portion of needle 36 is disposed within spring 40. The second axial end portion of needle 36 is connected to spring stop 42. Spring 40 biases needle 36 so that needle 36 sealingly engages with seat 38. Needle 36 and seat 38 are dimensioned so that fluid exiting housing 34 has a largely cone shaped pattern. Once needle 36, seat 38, spring 40 and spring stop 42 are connected to each other in this way to form the valve subassembly, the valve subassembly is inserted into and fixed within housing 34. In particular, seat 38 is welded within the inner surface of housing 34, such as with a laser weld. The components of the valve subassembly—needle 36, seat 38, spring 40 and spring stop 42—may be constructed from stainless steel or comparable materials.

As mentioned, attachment assembly 14 is connected to the downstream end of fluid injector 12 near fluid outlet 18 thereof. In one embodiment, first end 30 of housing 34 of attachment assembly 14 is laser welded to the downstream end of housing 15 of fluid injector 12. The connected end of housing 34 may be configured so that the connected end is press fit into the inner surface of the end of housing 15 before the laser welding. Alternatively, attachment assembly 14 may be attached to fluid injector 12 using other techniques, such as crimping, threaded engagement, brazing, etc.

With attachment assembly 14 connected to fluid injector 12, injector assembly 10 is formed as an outward opening injector, with fluid injector 12 utilized as the metering valve of injector assembly 10. Fluid injector 12 controls the flow of fluid through injector assembly 10, with the fluid discharged from injector assembly 10 having a spray pattern defined by attachment assembly 14 and particularly the dimensions of needle 36 and seat 38 of attachment assembly 14.

In use, fluid which entered the fluid path of fluid injector 12 via fluid inlet 16 is prevented from exiting the fluid path through fluid outlet 18 when coil 20A of fluid injector 12 is de-energized, which allows for the spring within fluid injector 12 to bias valve needle 24 so as to contact and sealingly engage with valve seat 26, thereby placing valve assembly 22 in the closed state. With no fluid build-up or pressure within housing 34 of attachment assembly 14 due to valve assembly 22 being closed, spring 40 urges needle 36 against seat 38 so as to prevent fluid from exiting attachment assembly 14 through second end 32. In this state, injector assembly 10 is closed. When coil 20A is energized, armature 20C is urged in the upstream direction towards fluid inlet 16, thereby separating the end of valve needle 24 from valve seat 26 so as to allow the fluid in the fluid path of fluid injector 12 to exit fluid injector 12 through fluid outlet 18. Such exiting fluid enters housing 34 of attachment assembly 14 which causes fluid pressure in housing 34 to build against spring stop 42 and/or needle 36 until the pressure overcomes the bias forces on needle 36 by spring 40 and causes needle 36 and spring stop 42 to move downwardly so that needle 36 separates from seat 38 and allows fluid in attachment assembly 14 and fluid injector 12 to exit injector assembly 10 via seat 38. In this state, injector assembly 10 is in the open position. The exiting fluid has a spray pattern dependent upon the dimensions of needle 36 and seat 38.

With injector assembly 10 using fluid injector 12 as a metering device and attachment assembly 14 providing a flow pattern for fluid exiting attachment assembly 14, injector assembly 10 utilizes an existing fluid injector having an inward opening injector valve and attachment assembly 14 to result in an integrated, unitary injector assembly. Attachment assembly 14 having an outward opening valve subassembly formed by needle 36, seat 38, spring 40 and spring stop 42 advantageously prevents coking at or around seat 38 and prevents needle 36 from sticking thereto. Injector assembly 10 finds use in applications in which injectors are susceptible to coking and/or valves sticking, such as DDUs.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fluid injector assembly, comprising:
a fluid injector comprising a first housing, a fluid inlet disposed at a first end of the first housing for receiving fluid, a fluid outlet disposed at a second end of the first housing for exiting fluid from the first housing, the first housing defining at least in part a fluid path through the first housing between the fluid inlet and the fluid outlet, the fluid injector further including an actuator unit and a valve assembly operably coupled thereto for selectively discharging fluid in the fluid path from the fluid outlet when the valve assembly is in an open state and for preventing fluid in the fluid path from exiting the fluid outlet when the valve assembly is in a closed state; and
an attachment assembly, comprising:
a second housing having a first end attached or attachable to the second end of the first housing and a second end, the second housing at least partly defining a fluid path between the first end of the second housing and the second end thereof;
a seat fixedly disposed within the second housing;
an attachment assembly needle movably disposed within the second housing and including a first end portion, the attachment assembly needle movable between a first position in which the first end portion of the attachment assembly needle contacts and provides a sealing engagement with the seat of the attachment assembly so as to prevent fluid from exiting the second housing through the second end thereof, and a second position in which the first end portion of the attachment assembly needle extends outwardly from the second end of the second housing and is spaced from the seat of the attachment assembly; and
a spring member disposed within the second housing and coupled to the attachment assembly needle so as to bias the attachment assembly needle towards the first position thereof and prevent fluid in the second housing from exiting the second housing through the second end thereof,
wherein when the valve assembly is in the open state, fluid in the fluid injector exits the fluid injector from the fluid outlet thereof and enters the fluid path of the second housing under pressure so as to cause the attachment assembly needle to overcome the bias of the spring member and move to the second position for allowing the fluid to exit the second housing from the second end thereof, and when the valve assembly is in the closed state, fluid in the fluid injector is prevented from passing into the fluid path of the second housing so as to cause the spring member to bias the attachment assembly needle to move to the second position and prevent the fluid from exiting the second housing from the second end thereof.

2. The fluid injector assembly of claim 1, wherein the valve assembly is an inward opening valve assembly.

3. The fluid injector assembly of claim 2, wherein the fluid injector is a gasoline based port fuel injector.

4. The fluid injector assembly of claim 3, wherein the fluid injector assembly forms a fuel injector for mounting to a cylinder head of a gasoline combustible engine.

5. The fluid injector assembly of claim 1, wherein the fluid injector assembly comprises an injector for a diesel dosing unit (DDU).

6. The fluid injector assembly of claim 1, wherein the second housing is laser welded to the second end of the first housing, and the seat of the attachment assembly is laser welded to the second housing.

7. The fluid injector assembly of claim 1, wherein the attachment assembly further includes a spring stop, a first end of the spring member is engaged with the spring stop and a second end of the spring member is engaged with the seat.

8. The fluid injector assembly of claim 7, wherein the spring stop is connected to an axial end of attachment assembly needle, the attachment assembly needle, the seat, the spring and the spring stop forming a subassembly of the attachment assembly.

9. A fluid injector assembly, comprising:
an attachment assembly, comprising:
a housing having a first end and a second end, the housing at least partly defining a fluid path between the first end of the housing and the second end thereof;
a seat fixedly disposed within the housing;
a needle movably disposed within the housing and including a first end portion, the needle movable between a first position in which the first end portion of the needle contacts and provides a sealing engagement with the seat so as to prevent fluid from exiting the housing through the second end thereof, and a second position in which the first end portion of the needle extends outwardly from the second end of the housing and is spaced from the seat of the attachment assembly for allowing fluid in the housing to exit the housing through the second end thereof; and
a spring member disposed within the housing and coupled to the needle so as to bias the needle towards the first position and prevent fluid in the housing from exiting the housing through the second end thereof,
wherein the first end of the housing is configured for attaching to a fluid outlet of a fluid injector such that the fluid path of the housing is in fluid communication with a fluid path of the fluid injector.

10. The fluid injector assembly of claim 9, further comprising a fluid injector, the fluid injector comprising an injector housing, a fluid inlet disposed at a first end of the injector housing for receiving fluid, a fluid outlet disposed at a second end of the injector housing for exiting fluid therefrom, the injector housing defining at least in part an injector fluid path through the injector housing between the fluid inlet and the fluid outlet, the fluid injector further comprising an actuator unit and a valve assembly operably coupled thereto for selectively discharging fluid in the injector fluid path from the fluid outlet when the valve assembly is in an open state and for preventing fluid in the injector fluid path from exiting the fluid outlet when the valve assembly is in a closed state, wherein the first end of the housing of the attachment assembly is connected to the fluid injector at or near the fluid outlet thereof.

11. The fluid injector assembly of claim 10, wherein the fluid injector is a fuel injector and the fluid injector assembly is a fuel injector or a diesel dosing unit (DDU) injector.

12. The fluid injector assembly of claim 10, wherein the fluid injector is a gasoline based port fuel injector.

13. The fluid injector of claim 10, wherein the valve assembly of the fluid injector is an inwardly opening valve assembly.

14. The fluid injector of claim 10, wherein when the valve assembly of the fluid injector is in the open state, fluid in the fluid injector exits the fluid injector from the fluid outlet thereof and enters the fluid path of the housing of the attachment assembly so as to cause the needle to overcome the bias of the spring member and move to the second position, and when the valve assembly of the fluid injector is in the closed state, fluid in the fluid injector is prevented from passing into the fluid path of the housing of the attachment assembly so as to cause the spring member to bias the needle of the attachment assembly to move to the first position.

15. The fluid injector assembly of claim 10, wherein the housing of the attachment assembly is laser welded to the second end of the injector housing, and the seat of the attachment assembly is laser welded to the housing thereof.

16. The fluid injector assembly of claim 9, wherein the attachment assembly further includes a spring stop disposed in the housing of the attachment assembly, a first end of the spring member is coupled to the spring stop and a second end of the spring member is coupled to the seat of the attachment assembly.

17. The fluid injector assembly of claim 16, wherein the spring stop is connected to an axial end of the needle, the needle, the seat, the spring and the spring stop forming a subassembly of the attachment assembly.
